(19) United States
(12) Patent Application Publication
(10) Pub. No.: US 2026/0352505 A1
(43) Pub. Date: Nov. 5, 2026

(54) IDENTITY SECURITY FOR ROBOTS AND AI AGENTS PARTICIPATING IN A COLLABORATION SESSION

(71) Applicant: MICROSOFT TECHNOLOGY LICENSING, LLC, Redmond, WA (US)

(72) Inventor: Daniel ROSENSTEIN, Issaquah, WA (US)

(21) Appl. No.: 19/195,607

(22) Filed: Apr. 30, 2025

(51) Int. Cl. H04L 12/18

(52) U.S. Cl. CPC H04L 12/1822; H04L 12/1818

(57) ABSTRACT

A system implements techniques for executing a collaboration session between at least one human participant, at least one robotic device participant, and at least one artificial intelligence agent participant. One particular challenge encountered when executing the collaboration session, or preparing to execute the collaboration session, relates to identity security. The disclosed system uses an identity platform to implement security measures for participants in relation to a collaboration session. For example, via the use of participant identifiers and the identity platform, the system determines if and/or how individual participants are authorized to join a collaboration session. In another example, via the use of participant identifiers and the identity platform, the system determines which functions participants are authorized to implement within a context of the collaboration session.

### BACKGROUND

The use of robotic devices is becoming more prevalent in the world. For instance, different types of robotic devices have recently been configured to perform various tasks for humans. In some cases, the performance of tasks by robotic devices replaces the need for humans to perform the tasks (e.g., dangerous tasks, time-consuming tasks). Thus, in many areas of life, robotic devices have been proven to improve the way in which people live.

The tasks that can be performed by robotic devices are becoming more complex. Furthermore, the tasks that can be performed by robotic devices are becoming interrelated. Unfortunately, existing systems fail to provide a way for effective and efficient coordination of robotic devices that are expected to perform complex and interrelated tasks. It is with respect to these and other considerations that the disclosure made herein is presented.

### SUMMARY

The system described herein implements techniques for executing a collaboration session between at least one human participant, at least one robotic device participant, and at least one artificial intelligence agent participant. One particular challenge encountered when executing the collaboration session, or preparing to execute the collaboration session, relates to identity security. The disclosed system uses an identity platform to implement security measures for participants in relation to a collaboration session. For example, via the use of participant identifiers and the identity platform, the system determines if and/or how individual participants are authorized to join a collaboration session. In another example, via the use of participant identifiers and the identity platform, the system determines which functions participants are authorized to implement within a context of the collaboration session.

As described herein, a robotic device is a programmable device configured to implement a series of physical actions automatically. In this context, “automatically” means the physical actions are implemented via the embedded programming of the robotic device and/or via remote control of the robotic device (e.g., in a scenario where a human and robotic device are not co-located).

In various examples described herein, the collaboration session is executed in relation to a mission to be completed within a geographical environment. A mission defines one or more goals. Accordingly, a mission typically includes a set of tasks to be completed to achieve the goals. In various examples, the mission is related to a response to an event and the set of tasks to be completed in accordance with the mission is distributed across available resources. More specifically, different human and/or robotic device roles may have varied responsibilities in implementing different tasks to complete the mission.

As an illustrative example, an event may be a natural disaster such as a fire from a lightning strike, a hurricane, or an earthquake. The use of robotic devices can be helpful in responding to a natural disaster event. Typically, multiple organizations respond to execute and/or complete a mission with the goal of helping people that are affected by the natural disaster event. For instance, first tasks for the mission may be related to finding and rescuing survivors (e.g., removing people from dangerous areas). Second tasks for the mission may be related to limiting further damage caused by the natural disaster event (e.g., finding areas where the fire is burning and extinguishing the fire, securing unstable buildings). Third tasks for the mission may be related to identifying damaged/offline “utility” infrastructure (e.g., electric grid infrastructure, water supply infrastructure, gas pipeline infrastructure) and fixing the damage/offline utility infrastructure so it comes back online in due time.

In the illustrative example of the preceding paragraph, the multiple organizations often include different government agencies from local, state, and/or federal jurisdictions. Moreover, the multiple organizations may include private and/or charitable organizations as well. Each of the organizations may include their own personnel, their own experiences and/or procedures with respect to deploying robotic devices, as well as their own execution and/or communications infrastructure to operate the robotic devices. When different personnel and different types of robotic devices from different organizations converge on a geographical environment in response to an event such as a natural disaster, it is difficult to coordinate the tasks so that the mission can be achieved in a more effective and efficient manner.

The collaboration session described herein creates an effective and efficient solution for humans and robotic devices to coordinate the performance of the mission. Additionally, the collaboration session described herein allows for artificial intelligence agents to assist in the coordination of the performance of the mission. For instance, via the execution of a collaboration session, humans from different organizations that use heterogenous robotic devices (e.g., different types of robotic devices, different types of communications) can quickly connect through a central system to collaborate and coordinate performance of tasks that are intended to complete a mission. Moreover, access to an intelligence layer provided by artificial intelligence agents that are able to participate in the collaboration session enhances the collaboration and coordination.

The illustrative example of a natural disaster event provided above is a larger-scale event. However, it is understood in the context of this disclosure that a mission can be implemented at different scales. For instance, a mission can also be implemented in response to a smaller-scale event that only requires coordination and collaboration between a limited number of humans (e.g., one, two, or three humans), a limited number of robotic devices (e.g., one, two, or three robotic devices), and a limited number of artificial intelligence agents (e.g., one, two, or three artificial intelligence agents). For example, a collaboration session may be generated for a human to coordinate with a robotic device and/or an artificial intelligence agent to find a particular team member (e.g., determine a current location of the particular team member) in an office building so the team member can resolve a project issue a team has encountered. In this example, the event is the project issue and the mission is finding the particular team member. In another example discussed herein, a collaboration session may be generated for humans to coordinate with robotic devices and/or artificial intelligence agents to execute tasks at a construction site.

As shown via the examples described above, the coordination enabled via the collaboration session described herein may be scaled to apply in any context in which work (e.g., a mission) needs to be done by a human, a robotic device, and an artificial intelligence agent. Various example contexts include disaster response, safety and security, healthcare and medical instrumentation, manufacturing and industrial lines/warehouses, office and/or personal management, agriculture, construction, and so forth. Accordingly, a geographical environment, as described herein, can include an identifiable “real-world” setting and/or area. The identifiable real-world setting and/or area can be indoor, such as an office building, a retail building, a personal residence, a warehouse, a hospital, a medical office, a factory floor, a manufacturing line, or other types of settings and/or areas within physical structures that can be blueprint-or human-defined. Alternatively, the identifiable real-world setting and/or area can be outdoor, such as a forest, a mountain, a construction site, a neighborhood, a town, a city, a county, a state, a country, a field, a pasture, or other type of outdoor settings and/or areas that can be map- or human-defined.

Robotic devices can operate on land, on water, in the air, in space, or a combination thereof, and can be programmed to perform different tasks. For example, an unmanned aerial vehicle (UAV) may be tasked with capturing video and/or dropping items from the sky. A sea drone may be tasked with capturing video and/or providing supplies to an area that cannot be reached by land. A bomb disposal robotic device may be tasked with capturing video and/or safely disabling an explosive device. A backhoe robotic device may be tasked with capturing video and/or moving dirt, rocks, and/or rubble. A dump truck robotic device may be tasked with capturing video and hauling away dirt, rocks, and/or rubble. An office or retail robotic device may be tasked with stocking retail and/or supply shelves. A warehouse robotic device may be tasked with sorting items in bins. A manufacturing robotic device may be tasked with connecting two parts of an apparatus. These example robotic devices are just a few of the numerous different types of robotic devices that have been manufactured and configured to perform various tasks in varying contexts.

Regardless of the size and/or scope of the mission and/or a scale of an event to which the mission responds, the collaboration session described herein enables at least one human and one robotic device to work together in conjunction with an artificial intelligence agent. The artificial intelligence agent can function as a translation and/or orchestration interface between the human and the robotic device. The collaboration session presents a low barrier of entry for humans and/or robotic devices to be part of a coordinated mission. Moreover, the collaboration session enables the integration of heterogenous robotic devices (e.g., different fleets of robotic devices) that are not designed and/or configured to communicate with one another. Moreover, through the use of the aforementioned accessible artificial intelligence agent, the collaboration session enables effective participation for humans without detailed working knowledge of the robotic devices deployed to the geographical environment in which the mission is being implemented, thereby reducing the cognitive load required for successful missions and increasing the overall efficiency for mission completion.

The humans, robotic devices, and/or artificial intelligence agents participating in a collaboration session are respectively referred to herein as human participants, robotic device participants, and artificial intelligence agent participants. The disclosed system is configured to expose an application programming interface that allows robotic devices to access and download a “robot agent” that enables robotic device participation in the collaboration session. The robot agent includes centralized code that configures the robotic devices with communication and/or configuration software that is compatible with the collaboration session. That is, after downloading the robot agent, a robotic device can participate in the collaboration session via the communication (e.g., transmission) of robot data.

In one example, the robot data includes sensor data sensed by a sensor embedded in a robotic device participant. More specifically, the sensor data can include one or more of image data (e.g., still images) captured by an image capture device embedded in or attached to the robotic device participant, video data (e.g., a sequence of video frames) captured by a video capture device embedded in or attached to the robotic device participant, audio data captured by a microphone embedded in or attached to the robotic device participant, temperature data captured by a thermometer embedded in or attached to the robotic device participant, air quality data captured by an air quality sensor embedded in or attached to the robotic device participant, pressure data captured by a pressure sensor embedded in or attached to the robotic device participant, velocity data captured by a velocity sensor embedded in or attached to the robotic device participant, smoke data captured by a smoke detecting sensor embedded in or attached to the robotic device participant, gas data captured by a gas detecting sensor embedded in or attached to the robotic device participant, thermal data captured by a thermal sensor embedded in or attached to the robotic device participant, depth data captured by a depth sensor embedded in or attached to the robotic device participant, odor (smell) data captured by an odor sensor embedded in or attached to the robotic device participant, lidar data captured by a laser component embedded in or attached to the robotic device participant, radar data captured by a radar component embedded in or attached to the robotic device participant, or infrared (IR) data captured by an IR sensor embedded in or attached to the robotic device participant. While a list of example types of data and/or sensors is provided above, it is understood in the context of this disclosure, that a robotic device participant can be configured with hardware, firmware, and/or software to detect and/or sense any type of environmental data. In another example, the robot data includes location data for the robotic device (e.g., a Global Positioning System (GPS) location).

The robot agent made available by the system via the application programming interface configures a bi-directional communication bridge between a robotic device and the collaboration session. More specifically, this bi-directional communication bridge connects the robotic device to cloud infrastructure that hosts the collaboration session via different types of networks including private and/or public local area networks (LANs), private and/or public metropolitan area networks (MANs), private and/or public wide area networks (WANs), Wi-Fi networks, public and/or private mobile networks (e.g., 5G networks, LTE networks), satellite networks, radio networks, and so forth.

As mentioned above, a particular challenge encountered when executing a collaboration session, or preparing to execute the collaboration session, relates to identity security. This challenge may be particularly relevant provided the increased sensitivity and/or increased complexity of various missions and/or geographical environments in which participants in the collaboration session belong to different organizations (examples of which are described above and further described herein). To ensure that a collaboration session is executed in a secure manner, the system described herein is configured to use an identity platform to implement security measures for participants in relation to a collaboration session.

The identity platform includes a datastore that stores parameters useable to determine if and/or how a participant joins a collaboration session. Additionally, the parameters can determine which functions participants can implement within a context of the collaboration session (after joining the collaboration session). Because the collaboration session does not only include human participants, but rather, robotic device participants and artificial intelligence agent participants as well, the datastore is configured to store an expanded set of parameters compared to traditional identity platforms. More specifically, a datastore for a traditional identity platform is configured with entries solely for human “users”, and thus, may simply store human user identifiers as well as organizations to which the human users belong.

However, the datastore described herein is configured with entries for robotic device participants and artificial intelligence agent participants in addition to human participants. Consequently, the aforementioned expanded set of parameters includes security and/or functional parameters that are tailored to the participation of robotic device participants and/or artificial intelligence (AI) agent participants in a collaboration session. The collaboration session is started, or scheduled to start, by an originator (referred to herein as an originating participant). The originating participant can be a human participant, a robotic device participant, or an AI agent participant

A first example security parameter in the expanded set of parameters indicates a type of participant (e.g., a type of user). The “type” parameter can be populated with “human”, “robotic device”, or “artificial intelligence agent” (i.e., “AI agent”). Accordingly, the type parameter distinguishes between the type of participant, e.g., a human participant, a robotic device participant, or an AI agent participant.

A second example security parameter in the expanded set of parameters indicates a link between at least two organizations (e.g., agencies, companies). If the “link” parameter indicates a link between two organizations, then a policy authorizes a robotic device participant or AI agent participant that belongs to a first of the two organizations to automatically join a collaboration session of an originating participant that belongs to a second of the two organizations. If the link parameter does not indicate a link between two organizations, then the robotic device or AI agent participant that belongs to the first of the two organizations is required to be accepted into the collaboration session by the originating participant (or another participant with acceptance privileges) that belongs to the second of the two organizations. For instance, the collaboration session can display a prompt asking the originating participant to accept the participant into the collaboration session.

A third example security parameter in the expanded set of parameters indicates external data access for linked organizations. If two or more organizations are linked for purposes of automatic joining, then the “data access” parameter enables additional collaboration such that the robotic device participant or AI agent participant from the first of the two organizations can access data of the second of the two organizations that is stored in a designated area of an external cloud service. External in this context means outside a system dedicated to hosting and executing the collaboration session and outside a system that configures and operates the identity platform and datastore. The data can include files, workloads, etc. that are capable of supporting functions implemented by robotic device participants and/or AI agent participants.

A fourth example security parameter in the expanded set of parameters indicates a current location of a robotic device participant. As many robotic devices are mobile (e.g., capable of moving from one geographical location to another geographical location), knowing their current location may be relevant when determining which robotic devices can assist with tasks related to a mission. Accordingly, the “location” parameter can be used to identify a group of robotic device participants that can assist with tasks related to a mission being conducted in a particular geographical environment.

As mentioned above, the expanded set of parameters can include functional parameters in addition to security parameters. A functional parameter defines, or indicates, a functional characteristic of a participant. A first example functional parameter in the expanded set of parameters includes a “role” parameter. A role reflects functions, parts, or tasks that a participant can perform in a particular operation or process. For instance, a role parameter for a human participant can reflect a position related to employment and/or an event (e.g., a job title, forest fire response coordinator). A role parameter for a robotic device participant can reflect a specific type of robotic device (e.g., an unmanned aerial vehicle (UAV), a bomb disposal robotic device) and/or a manufacturer of the robotic device. A role parameter for an AI agent participant can reflect a specific type of AI agent (e.g., a specific-purpose AI agent or a general-purpose AI agent).

Second example functional parameters in the expanded set of parameters include “capability” parameters. A capability parameter defines tasks that a participant can execute. That is, the capability parameter defines tasks that the participant has been trained, configured, manufactured, etc. to complete. For instance, a capability parameter for a human participant can include a certification to operate a specific type of robotic device (e.g., a UAV), e.g., in response to a particular type of an event. A capability parameter for a robotic device participant can include various hardware (e.g., sensors) that can be deployed and used, e.g., in response to a particular type of an event. A capability parameter for an AI agent participant can include AI-based tasks (e.g., object detection, resource identification and management) that can be used, e.g., in response to a particular type of an event.

A third example functional parameter in the expanded set of parameters includes a “view” parameter. A view parameter provides privileges for a human participant to view video streams received from robotic device participants that are operating in the geographical environment. Without a defined view parameter, a human participant may be presented with a static graphical representation of a robotic device.

The system described herein receives, from an originating participant, a request to generate a collaboration session related to a mission to be completed within a geographical environment. In one example described herein, the request includes a query useable to identify other participants to invite to the collaboration session. In response to receiving the request, the system access the datastore to retrieve identifiers that include a parameter that satisfies the query. The system then sends an invitation to join the collaboration session to a plurality of participants corresponding to the identifiers retrieved from the datastore. As described above, the plurality of participants include a human participant, a robotic device participant, and an artificial intelligence agent participant. The system then executes the collaboration session by enabling the plurality of participants to join the collaboration session based on the invitation to join, generating an interaction environment for the collaboration session, and providing the interaction environment to a computing device associated with the human participant. As described in further detail below, the interaction environment includes a graphical representation for each of the plurality of participants that have joined the collaboration session. Moreover, the system provides a context of the whole interaction environment, or a particular aspect of the interaction environment (e.g., a video stream), to an AI agent participant for processing and analysis.

This Summary is provided to introduce a selection of concepts in a simplified form that are further described blow in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 illustrates an example environment in which a system accesses a datastore to retrieve security and/or functional parameters for a plurality of participants in a collaboration session.

FIG. 2A illustrates an example datastore with example security and/or functional parameters that are used to authorize participants with respect to joining a collaboration session and/or implementing a function within a context of the collaboration session.

FIG. 2B illustrates the example datastore of FIG. 2A in which a data access parameter enables access to data stored via an external service and/or system.

FIG. 3 illustrates further aspects of the system executing a collaboration session that accesses a datastore to retrieve security and/or functional parameters for a plurality of participants in a collaboration session.

FIG. 4A illustrates an example interaction environment of a communication session where participants are identified based on parameters satisfying a query and joined automatically.

FIG. 4B illustrates the example interaction environment of FIG. 4A where participants are identified based on parameters satisfying a query and need to be accepted to join.

FIG. 4C illustrates an example interaction environment of FIG. 4B, where all participants have joined.

FIG. 5A illustrates an example interaction environment in which a functional parameter is used to authorize a participant to implement a function (e.g., robotic device teleoperation) within the context of the collaboration session.

FIG. 5B illustrates an example interaction environment in which a functional parameter is used to authorize a participant to implement a function (e.g., the viewing of robotic device video streams) within the context of the collaboration session.

FIG. 6 illustrates a process for accesses a datastore to retrieve security and/or functional parameters useable to authorize human participants, robotic device participants, and/or artificial intelligence agent participants to join a collaboration session and/or to implement functions within the context of the collaboration session.

FIG. 7 is a computer architecture diagram illustrating an illustrative computer hardware and software architecture for a computing system capable of implementing aspects of the techniques and technologies presented herein.

### DETAILED DESCRIPTION

The system described herein implements techniques for executing a collaboration session between at least one human participant, at least one robotic device participant, and at least one artificial intelligence agent participant. One particular challenge encountered when executing the collaboration session, or preparing to execute the collaboration session, relates to identity security. The disclosed system uses an identity platform to implement security measures for participants in relation to a collaboration session. For example, via the use of participant identifiers and the identity platform, the system determines if and/or how individual participants are authorized to join a collaboration session. In another example, via the use of participant identifiers and the identity platform, the system determines which functions participants are authorized to implement within a context of the collaboration session.

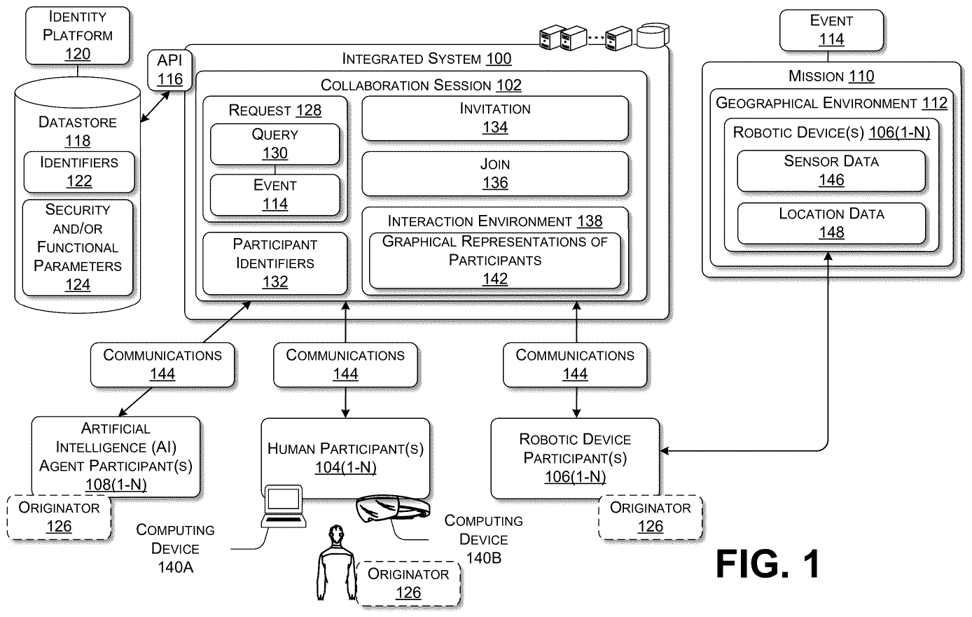

FIG. 1 illustrates an example environment in which a system 100 generates and/or executes a collaboration session 102 between one or more human participant(s) 104(1-N), one or more robotic device participant(s) 106(1-N), and one or more artificial intelligence (AI) agent participant(s) 108(1-N). The number N represents a positive integer number and can be the same or different for the human participants 104(1-N), the robotic device participants 106(1-N), and the AI agent participants 108(1-N). For example, the numbers for the different types of participants can be smaller (e.g., one, two, three, four) if the collaboration session 102 is small in scale. Alternatively, the numbers for the different types of participants can be larger (e.g., five, ten, fifteen, fifty) if the collaboration session 102 is large in scale.

The system 100 is “integrated” in the sense that it seamlessly provides common collaboration session features so that the human participant(s) 104(1-N), the robotic device participant(s) 106(1-N), and the AI agent participant(s) 108(1-N) can all work together toward a mission 110 to be completed within a geographical environment 112. That is, the collaboration session 102 may be executed in relation to the mission 110 and the geographical environment 112. The mission 110 may be related to a response to an event 114 and a set of tasks to be completed in accordance with the mission 110 is distributed across different human and/or robotic devices with varied responsibilities. Consequently, the robotic device participants 106(1-N) reflect robotic devices that are operating and physically located in the geographical environment 112. A robotic device participant 106 is a programmable device configured to implement a series of physical actions automatically. In this context, “automatically” means the physical actions are implemented via the embedded programming of the robotic device participant 106 and/or via remote control of the robotic device participant 106 (e.g., when a human and robotic device are not co-located).

As an illustrative example, an event 114 may be a natural disaster such as a fire from a lightning strike, a hurricane, or an earthquake. The use of robotic devices 106(1-N) can be helpful in responding to a natural disaster event. Typically, multiple organizations respond to execute and/or complete a mission 110 with the goal of helping people that are affected by the natural disaster event. For instance, first tasks for the mission 110 may be related to finding and rescuing survivors (e.g., removing people from dangerous areas). Second tasks for the mission 110 may be related to limiting further damage caused by the natural disaster event (e.g., finding areas that are burning and extinguishing the fire, securing unstable buildings). Third tasks for the mission 110 may be related to identifying damaged/offline “utility” infrastructure (e.g., electric grid infrastructure, water supply infrastructure, gas pipeline infrastructure) and fixing the damage/offline utility infrastructure so it comes back online in due time.

In this illustrative example, the multiple organizations often include different government agencies from local, state, and/or federal jurisdictions. Moreover, the multiple organizations may include private and/or charitable organizations as well. Each of the organizations may include their own personnel (e.g., the human participants 104(1-N)), their own experiences and/or procedures with respect to deploying robotic devices 106(1-N) to the geographical environment 112 in which the event 114 occurs, as well as their own execution and/or communications infrastructure to operate the robotic devices 106(1-N). When different personnel and different types of robotic devices 106(1-N) from different organizations converge on the geographical environment 112 in response to an event 114 such as a natural disaster, it is difficult to coordinate the tasks so that the mission can be achieved in a more effective and efficient manner.

The collaboration session 102 creates an effective and efficient solution for human participants 104(1-N) and robotic device participants 106(1-N) to coordinate the performance of the mission 110 in the geographical environment 112 in response to the event 114. Additionally, the collaboration session 102 allows for the AI agent participants 108(1-N) to assist in the coordination of the performance of the mission 110 in the geographical environment 112. For instance, via the execution of the collaboration session 102, humans from different organizations that use heterogenous robotic devices (e.g., different types of robotic devices, different types of communications) can quickly connect through a central, integrated system 100 to collaborate and coordinate performance of tasks that are intended to complete the mission 110.

The illustrative example of a natural disaster event provided above is a larger-scale event 114. However, it is understood in the context of this disclosure that a mission 110 can be implemented at different scales. For instance, a mission 110 can also be implemented in response to a smaller-scale event 114 that only requires coordination and collaboration between a limited number of humans (e.g., one, two, or three humans), a limited number of robotic devices (e.g., one, two, or three robotic devices), and a limited number of artificial intelligence agents (e.g., one, two, or three artificial intelligence agents). For example, a human participant 104 may generate a collaboration session 102 to coordinate with a robotic device participant 106 and/or an AI agent participant 108 to find a particular team member (e.g., determine a current location of the particular team member) in an office building so the team member can resolve a project issue a team has encountered. In this example, the event 114 is the project issue and the mission 110 is finding the particular team member in the office building, which represents the geographical environment 112. In another example discussed herein, a collaboration session 102 may be generated for human participants 104(1-N) to coordinate with robotic device participants 106(1-N) and/or artificial intelligence agent participants 108(1-N) to execute event-related tasks at a construction site.

Consequently, the coordination enabled via a collaboration session 102 described herein may be scaled to apply in any context in which work (e.g., a mission 110) needs to be done by a human, a robotic device, and an AI agent. Various contexts include disaster response, safety and security, healthcare and medical instrumentation, manufacturing and industrial lines/warehouses, office and/or personal management, agriculture, construction, and so forth. Accordingly, a geographical environment 112, as described herein, can include an identifiable “real-world” setting and/or area. The identifiable real-world setting and/or area can be indoor, such as an office building, a retail building, a personal residence, a warehouse, a hospital, a medical office, a factory floor, a manufacturing line, or other types of settings and/or areas within physical structures that can be blueprint-or human-defined. Alternatively, the identifiable real-world setting and/or area can be outdoor, such as a forest, a mountain, a construction site, a neighborhood, a town, a city, a county, a state, a country, a field, a pasture, or other type of outdoor settings and/or areas that can be map-or human-defined.

Robotic device participants 106(1-N) can operate on land, on water, in the air, in space, or a combination thereof, and can be programmed to perform different tasks. For example, an unmanned aerial vehicle (UAV) may be tasked with capturing video and/or dropping items from the sky. A sea drone may be tasked with capturing video and/or providing supplies to an area that cannot be reached by land. A bomb disposal robotic device may be tasked with capturing video and/or safely disabling an explosive device. A backhoe robotic device may be tasked with capturing video and/or moving dirt, rocks, and/or rubble. A dump truck robotic device may be tasked with capturing video and hauling away dirt, rocks, and/or rubble. An office or retail robotic device may be tasked with stocking retail and/or supply shelves. A warehouse robotic device may be tasked with sorting items in bins. A manufacturing robotic device may be tasked with connecting two parts of an apparatus. These example robotic devices are just a few of the numerous different types of robotic devices that have been manufactured and configured to perform various tasks in varying contexts.

As mentioned above, a particular challenge encountered when executing a collaboration session 102, or preparing to execute the collaboration session 102, relates to identity security. This challenge may be particularly relevant provided the increased sensitivity and/or increased complexity of various missions 110 and/or geographical environments 112 in which participants (e.g., human participants 104(1-N), robotic device participants 106(1-N), AI agent participants 108(1-N)) in the collaboration session 102 belong to different organizations. To ensure that the collaboration session 102 is executed in a secure manner, the system 100 described herein is configured to access, via an application programming interface (API) 116, a datastore 118 that is configured and operated in association with an identity platform 120. While the datastore 118 and/or the identity platform 120 can be outside the system 100 in one embodiment, in another embodiment, the datastore 118 and/or the identity platform 120 can be part of the system 100.

The datastore 118 stores identifiers 122 that include parameters 124 useable to determine if and/or how a participant joins the collaboration session 102. Additionally, the parameters 124 can determine which functions participants can implement within a context of the collaboration session 102 (after joining the collaboration session 102). Because the collaboration session 102 does not only include human participants 104(1-N), but rather, robotic device participants 106(1-N) and AI agent participants 108(1-N) as well, the parameters 124 stored in the datastore 118 is an expanded set of parameters compared to traditional identity platforms. More specifically, a datastore for a traditional identity platform is configured with entries solely for human “users”, and thus, may simply store human user identifiers as well as organizations to which the human users belong.

However, the datastore 118 described herein is configured with entries for robotic device participants 106(1-N) and AI agent participants 108(1-N) in addition to human participants 104(1-N). The expanded set of parameters includes security and/or functional parameters that are tailored to the participation of robotic device participants 106(1-N) and/or AI agent participants 106(1-N) in the collaboration session 102, and therefore, the parameters 124 are referred to as “security and/or functional” parameters in FIG. 1.

The collaboration session 102 is generated and/or started, or scheduled to start, by an originator 126 (referred to herein as an originating participant). As shown in FIG. 1, the originator 126 can be a human participant 104, a robotic device participant, 106 or an AI agent participant 108. The originator 126 creates a request 128 to generate and/or start the collaboration session 102 and sends the request 128 to the system 100.

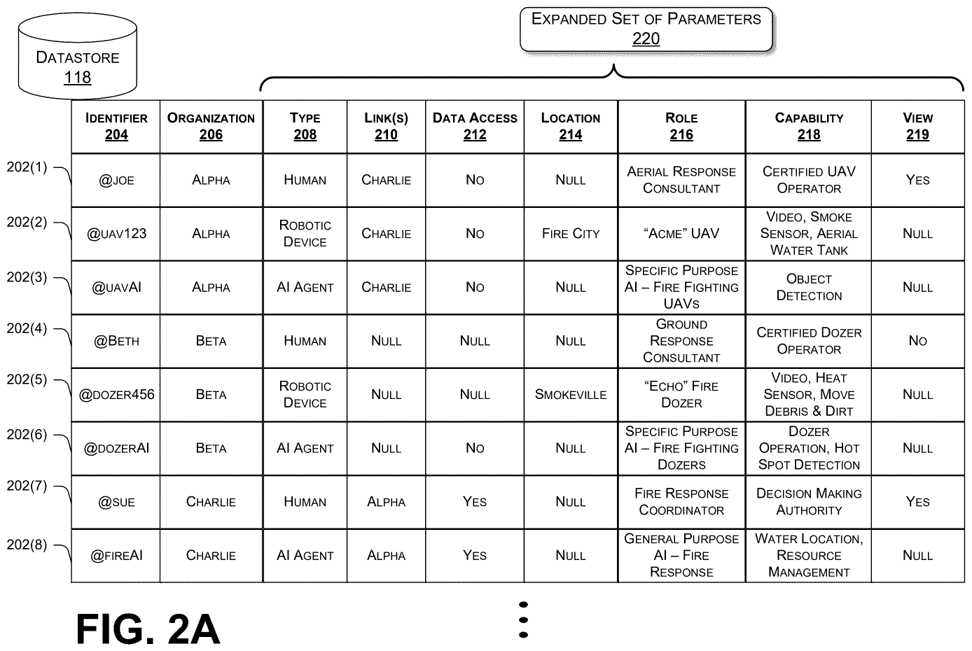

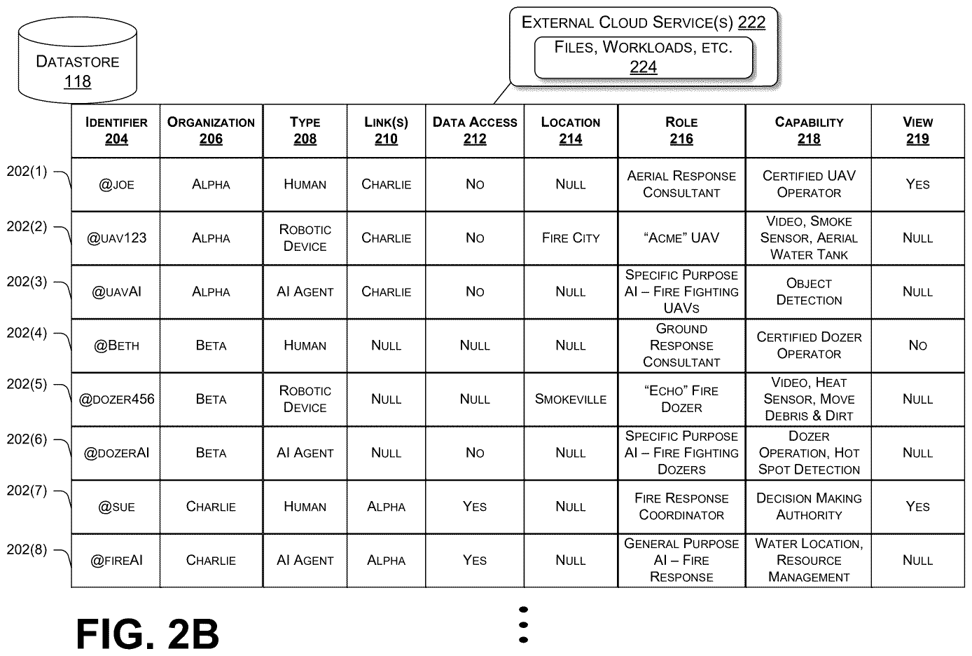

Accordingly, the system 100 receives, from the originator 126, the request 128 to generate the collaboration session 102 related to a mission 110 to be completed within a geographical environment 112. In one example, the request 128 includes a query 130 useable to identify other participants to invite to the collaboration session 102. For instance, the query 130 may include information related to the event 114. In response to receiving the request 128, the system 100 access the datastore 118 to retrieve identifiers 132 (e.g., a subset of identifiers 122) that include a parameter 124 that satisfies the query 130. Examples parameters 124 and example scenarios of a parameter 124 satisfying the query 130 are described herein with respect to FIG. 2A-2B.

The retrieved identifiers 132 corresponds to the human participants 104(1-N), the robotic device participants 106(1-N), and the AI agent participants 108(1-N) that are to be invited to join the collaboration session 102. Accordingly, the system 100 generates and sends an invitation 134 to join the collaboration session 102 to the human participants 104(1-N), the robotic device participants 106(1-N), and the AI agent participants 108(1-N). The system 100 then executes the collaboration session 102 by enabling the human participants 104(1-N), the robotic device participants 106(1-N), and the AI agent participants 108(1-N) to join 136 the collaboration session 102 based on the invitation 134. Execution of the collaboration session 102 includes generating an interaction environment 138 for the collaboration session 102 and providing the interaction environment 138 to a computing device 140A-B associated with the human participant 104. The interaction environment 138 includes a graphical representation 142 for each of the human participants 104(1-N), the robotic device participants 106(1-N), and the AI agent participants 108(1-N) that have joined the collaboration session 102. In this way, the human participants 104(1-N) can view and/or interact with various resources (e.g., robotic device participants 106(1-N), AI agent participants 108(1-N)) that are available and/or deployed to assist in completion of the mission 110 in response to an event 114.

In one example, the interaction environment 138 is displayed on a computing screen in two-dimensions, and thus, the computing device 140A can be a desktop computer, a gaming device, a tablet computer, a personal data assistant (PDA), a laptop computer, a telecommunication device (e.g., a smartphone), a wearable device (e.g., a smartwatch), an automotive computer, a network-enabled television, or any other sort of computing device capable of displaying the interaction environment 138 in two dimensions. In another example, the interaction environment 138 is displayed in an immersive environment that includes more than two dimensions (e.g., a 3D environment), and thus, the computing device 140B can be a virtual reality (VR) computing device, an augmented reality (AR) computing device, or a mixed reality (MR) computing device.

FIG. 1 further illustrates that the system 100 enables communications 144 between the collaboration session 102 and each of the human participants 104(1-N), the robotic device participants 106(1-N), and the AI agent participants 108(1-N) that have joined the collaboration session 102. In one example, the communications 144 allow for the robotic device participants 106(1-N) to transmit sensor data 146 and/or location data 148 to the collaboration session 102. The sensor data 146 can include one or more of image data (e.g., still images) captured by an image capture device embedded in or attached to the robotic device participant, video data (e.g., a sequence of video frames) captured by a video capture device embedded in or attached to the robotic device participant, audio data captured by a microphone embedded in or attached to the robotic device participant, temperature data captured by a thermometer embedded in or attached to the robotic device participant, air quality data captured by an air quality sensor embedded in or attached to the robotic device participant, pressure data captured by a pressure sensor embedded in or attached to the robotic device participant, velocity data captured by a velocity sensor embedded in or attached to the robotic device participant, smoke data captured by a smoke detecting sensor embedded in or attached to the robotic device participant, gas data captured by a gas detecting sensor embedded in or attached to the robotic device participant, thermal data captured by a thermal sensor embedded in or attached to the robotic device participant, depth data captured by a depth sensor embedded in or attached to the robotic device participant, odor (smell) data captured by an odor sensor embedded in or attached to the robotic device participant, lidar data captured by a laser component embedded in or attached to the robotic device participant, radar data captured by a radar component embedded in or attached to the robotic device participant, or infrared (IR) data captured by an IR sensor embedded in or attached to the robotic device participant. While a list of example types of data and/or sensors is provided above, it is understood in the context of this disclosure, that a robotic device participant 106 can be configured with hardware, firmware, and/or software to detect and/or sense any type of environmental data. The location data 148 can reflect a location, or position, of a robotic device participant 106 in the geographical environment 112 (e.g., a Global Positioning System (GPS) location).

In another example, the communications 144 allow for the human participants 104(1-N) to transmit and/or receive individual streams of data corresponding to the participants 104(1-N), 106(1-N), 108(1-N), such as audio and/or visual data that capture the appearance and speech of a participant in the collaboration session, a video stream, or video feed, from a camera embedded on a robotic device, and so forth.

In yet another example, the communications 144 allow for the AI agent participants 108(1-N) to receive a context of the interaction environment 138 in a consumable format (e.g., code-based format), as stored in a data structure for the collaboration session 102. Access to the context of the whole interaction environment 138, or a particular aspect of the interaction environment 138 (e.g., a video stream from a robotic device participant 106) enables an AI agent participant 108 to understand and/or analyze particular characteristics of the collaboration session 102.

Consequently, regardless of the size and/or scope of the mission 110 and/or a scale of an event 114 to which the mission 110 responds, the collaboration session 102 described herein enables the different types of participants 104(1-N), 106(1-N), 108(1-N) to work together to complete the mission 110. The collaboration session 102 presents a low barrier of entry for humans and/or robotic devices to be part of a coordinated mission 110. Moreover, the collaboration session 102 enables the integration of heterogenous robotic devices (e.g., different fleets of robotic devices) that are not designed and/or configured to communicate with one another. Moreover, through the use of the accessible AI agents, the collaboration session 102 enables effective participation for humans without detailed working knowledge of the robotic devices deployed to the geographical environment 112 in which the mission 110 is being implemented, thereby reducing the cognitive load required for successful missions and increasing the overall efficiency for mission completion.

FIG. 2A illustrates a datastore 118 with example security and/or functional parameters that are used to authorize participants with respect to joining a collaboration session 102 and/or implementing a function within a context of the collaboration session 102. As described above, the datastore 118 is a queryable datastore 118. For example, the system 100 can issue a query 130 to the datastore 118 and the datastore 118 can return identifiers 122 and/or parameters 124 that satisfy the query 130. A parameter 124 satisfies a query 130 if an alphanumeric string (e.g., a word, a phrase) in the parameter 124 matches, or is semantically related to, an alphanumeric string in the query 130. For example, the query 130 can include alphanumeric strings that identify an event 114 (e.g., a forest fire), an organization (e.g., “Alpha” agency or company) generally known to have participants that can assist with completion of a mission 110 in response to an event 114, a capability generally known to assist with completion of a mission 110 in response to an event 114, and/or a general location in which an event 114 occurs and/or the mission 110 is to be completed. Accordingly, the datastore 118 can determine which identifiers 122 include parameters 124 that have alphanumeric strings that match, or are semantically related to, the alphanumeric strings in the query 130.

In various examples, an embedding model is configured to generate embeddings for the alphanumeric strings contained in the query 130 (e.g., text embeddings). Generally described, embeddings are mathematical structures (e.g., multidimensional vectors) that numerically represent the meaning of the alphanumeric strings contained in the query 130 (e.g., the semantic content of the query 130). Accordingly, embeddings can be used to determine whether a parameter 124 satisfies the query 130.

The datastore 118 shown in FIG. 2A (and subsequent FIGS.) includes eight entries 202(1-8) for simplicity and ease of discussion. However, it is understood in the context of this disclosure, that a datastore 118 can include thousands, or even millions, of entries (e.g., based on different humans, robotic devices, and AI agents that have accounts registered to participate in a collaboration session 102). Moreover, the datastore 118 is configured to store structured data so that identifiers 122 and parameters 124 can be retrieved. Therefore, the columns in the datastore of FIG. 2A reflect an identifier 204 for a user (e.g., a human user, a robotic device user, an AI agent user), as well as parameters for an organization 206 to which the user belongs, a type 208 of user, link(s) 210 for organizations and/or users, data access 212 for organizations and/or users, a location 214 of a robotic device user, a role 216 for a user, a capability 218 of a user, and a view 219 parameter for a human user.

FIG. 2A highlights that the datastore 118 is configured to store an expanded set of parameters 220 due to an ability for robotic device users and/or AI agent users to participate in a collaboration session. Moreover, the expanded set of parameters 220 are useable to determine how human participants 104(1-N) can interact with robotic device participants 106(1-N) and/or AI agent participants 106(1-N) in the context of a collaboration session 102.

The datastore 118 includes an entry 202(1) for an identifier 204 “@joe”, an entry 202(2) for an identifier 204 “@uav123”, an entry 202(3) for an identifier 204 “@uavAI”, an entry 202(4) for an identifier 204 “@beth”, an entry 202(5) for an identifier 204 “@dozer456”, an entry 202(6) for an identifier 204 “@dozerAI”, an entry 202(7) for an identifier 204 “@sue”, and an entry 202(8) for an identifier 204 “@fireAI”. The identifiers 204 can be in any one of various formats, as long as one identifier distinguishes from other identifiers in the datastore 118.

As shown in entry 202(1), “@joe” belongs to the organization 206 “Alpha” (e.g., “@joe” is employed by Alpha). As shown in entry 202(2), “@uav123” also belongs to the organization 206 “Alpha” (e.g., “@uav123” is a robotic device owned and/or operated by Alpha). As shown in entry 202(3), “@uavAI” also belongs to the organization 206 “Alpha” (e.g., “@uavAI” is an AI agent, trained, programmed and/or configured for use by Alpha). As shown in entry 202(4), “@beth” belongs to the organization 206 “Beta”. As shown in entry 202(5), “@dozer456” also belongs to the organization 206 “Beta”. As shown in entry 202(6), “@dozerAI” also belongs to the organization 206 “Beta”. As shown in entry 202(7), “@sue” belongs to the organization 206 “Charlie”. As shown in entry 202(8), “@fireAI” also belongs to the organization 206 “Charlie”.

The type 208 parameter is a security parameter that is populated with a type of user, e.g., “human”, “robotic device”, or “AI agent”. Accordingly, the type 208 parameter distinguishes between types of users. As shown in entry 202(1), the type 208 parameter for “@joe” is a human user. As shown in entry 202(2), the type 208 parameter for “@uav123” is a robotic device user. As shown in entry 202(3), the type 208 parameter for “@uavAI” is an AI agent user. As shown in entry 202(4), the type 208 parameter for “@beth” is a human user. As shown in entry 202(5), the type 208 parameter for “@dozer456” is a robotic device user. As shown in entry 202(6), the type 208 parameter for “@dozerAI” is an AI agent user. As shown in entry 202(7), the type 208 parameter for “@sue” is a human user. As shown in entry 202(8), the type 208 parameter for “@fireAI” is an AI agent user.

The link 210 parameter is a security parameter indicating a link between at least two organizations. If the link 210 parameter indicates a link between two organizations, then a policy authorizes a robotic device participant 106 or an AI agent participant 108 that belongs to a first of the two organizations to automatically join a collaboration session 102 of an originating participant that belongs to a second of the two organizations. If the link 210 parameter does not indicate a link between two organizations, then the robotic device 106 or the AI agent participant 108 that belongs to the first of the two organizations is required to be accepted into the collaboration session 102 by the originating participant (or another participant with acceptance privileges) that belongs to the second of the two organizations.

As shown in entries 202(1-3) and 202(7-8), the link 210 parameter indicates that the there is a defined link between the Alpha and Charlie organizations. However, as shown in entries 204(4-6), the link 210 parameter indicates that the Beta organization is not linked (e.g., via the “null”) to any other organization. In this example, if “@sue” generates and/or starts a collaboration session 102, then “@fireAI” can automatically join the collaboration session 102 by virtue of belonging to the same organization as “@sue” (i.e., the Charlie organization). Moreover, “@uav123” and “uavAI” can automatically join the collaboration session 102 by virtue of the link 210 parameter linking the Alpha organization to the Charlie organization. However, “@dozer456” and “dozerAI” are required to be accepted into the collaboration session by “@sue” because the link 210 parameter does not link the Beta organization to the Charlie organization.

The data access 212 parameter is a security parameter indicating external data access for linked organizations. If two or more organizations are linked via the link 210 parameter for purposes of automatic joining, then the data access 212 parameter enables additional collaboration. For example, if the data access 212 parameter is defined then a robotic device participant or AI agent participant from the first of the two organizations can access data of the second of the two organizations that is stored in a designated area of an external cloud service 222, as shown in FIG. 2B. External in this context means outside the system 100 dedicated to hosting and executing the collaboration session 102 and/or outside a system that configures and operates the identity platform 120 and datastore 118. The data can include files, workloads, etc. 224 that are capable of supporting functions performed by robotic device participants 106 and/or AI agent participants 108.

As shown in entries 202(1-3), the data access 212 parameter indicates that users belonging to the Alpha organization do not have data access to files, workloads, etc. 224 stored by the external cloud service 222 in association with the Charlie organization. However, as shown in entries 202(7-8), the data access 212 parameter indicates that users belonging to the Charlie organization do have data access to files, workloads, etc. 224 stored by the external cloud service 222 in association with the Alpha organization.

The location 214 parameter is a security parameter indicating a current location of a robotic device participant, e.g., as reported by the robotic device via GPS or another type of location determination technique. As many robotic devices are mobile (e.g., capable of moving from one geographical location to another geographical location), knowing their current location may be relevant when determining which robotic devices can assist with tasks related to a mission 110 being implemented in response to an event 114. Accordingly, the location 214 parameter can be used, in association with a query 130, to identify a group of robotic device participants that can assist with tasks related to the mission 110, as they are already located in close proximity to a particular geographical environment in which the mission 110 is conducted. As shown in entry 202(2), the location 214 parameter indicates that “uav123” is currently located in “Fire City”, while the location 214 parameter for entry 202(5) indicates that “dozer456” is currently located in “Smokeville”.

As mentioned above, the expanded set of parameters 220 can include functional parameters in addition to security parameters. A functional parameter defines, or indicates, a functional characteristic of a user or participant. A first example functional parameter is the role 216 parameter. A role reflects functions, parts, or tasks that a user can perform in a particular operation or process. For instance, the role 216 parameter for a human user can reflect a position related to employment and/or an event. The role 216 parameter for a robotic device user can reflect a specific type of robotic device and/or a manufacturer of the robotic device. A role parameter for an AI agent user can reflect a specific type of AI agent.

A first example type of AI agent includes a general-purpose type of AI agent. A general-purpose type of AI agent is one that provides general intelligence to mission execution (e.g., general fire response procedures for a forest fire, general construction safety practices for a construction site). A second example type of AI agent includes a specific-purpose type of AI agent. A specific-purpose type of AI agent is one that is dedicated to providing support for a specific type of robotic device, and thus, provides specific intelligence to mission execution. Consequently, a specific-purpose type of AI agent is configured and trained at a lower level to support tasks capable of being executed by a specific type of robotic device, while a general-purpose type of AI agent is configured and trained at a higher level to support more general goals, strategies, policies, and/or practices related to a mission 110.

As shown in entry 202(1), the role 216 parameter indicates “@joe” is an “aerial response consultant”. As shown in entry 202(2), the role 216 parameter indicates “@uav123” is a UAV manufactured by “Acme”. As shown in entry 202(3), the role 216 parameter indicates “@uavAI” is a specific-purpose type of AI that supports fire-fighting UAVs. As shown in entry 202(4), the role 216 parameter indicates “@beth” is a “ground response consultant”. As shown in entry 202(5), the role 216 parameter indicates “@dozer456” is a fire dozer manufactured by “Echo”. As shown in entry 202(6), the role 216 parameter indicates “@dozerAI” is a specific-purpose type of AI that supports fire-fighting dozers. As shown in entry 202(7), the role 216 parameter indicates “@sue” is a “fire response coordinator”. As shown in entry 202(8), the role 216 parameter indicates “@fireAI” is a general-purpose type of AI that supports fire response.

A second example functional parameter is the capability 218 parameter. A capability 218 parameter defines tasks that a user can implement. That is, the capability 218 parameter defines tasks that the user has been trained, configured, manufactured, etc. to complete. For instance, a capability 218 parameter for a human user can include a certification to operate a specific type of robotic device, e.g., in response to a particular type of an event 114. A capability 218 parameter for a robotic device participant can include various hardware (e.g., sensors) that can be deployed and used, e.g., in response to a particular type of an event 114. A capability 218 parameter for an AI agent participant can include AI-based tasks (e.g., object detection, resource identification and management) that can be used, e.g., in response to a particular type of an event 114.

As shown in entry 202(1), the capability 218 parameter indicates “@joe” is a certified UAV operator. As shown in entry 202(2), the capability 218 parameter indicates “@uav123” can obtain video and includes a smoke sensor and an aerial water tank (e.g., capable of dropping water). As shown in entry 202(3), the capability 218 parameter indicates “@uavAI” can analyze the video to implement object detection (e.g., to detect humans that need help or physical structures in danger of burning). As shown in entry 202(4), the capability 218 parameter indicates “@beth” is a certified dozer operator. As shown in entry 202(5), the capability 218 parameter indicates “@dozer456” can obtain video and includes a heat sensor as well as mechanism(s) to move (e.g., push) debris and/or dirt. As shown in entry 202(6), the capability 218 parameter indicates “@dozerAI” can analyze sensed data to automatically operate a dozer robotic device and to detect hot spots. As shown in entry 202(7), the capability 218 parameter indicates “@sue” has decision making authority regarding fire response resource management. As shown in entry 202(8), the capability 218 parameter indicates “@fireAI” can analyze data to locate water sources and/or automatically manage fire response resources.

The view 219 parameter is a functional parameter indicating whether a human participant has privileges to view video streams received from robotic device participants that are operating in the geographical environment. Without a defined view 219 parameter, a human participant may be presented with a static graphical representation of a robotic device. In the example of FIG. 2A, the view 219 parameters in entries 202(1) and 202(7) indicate that “@joe” and “@sue” have viewing privileges, while the view 219 parameter in entry 202(4) indicates that “@beth” does not have viewing privileges.

Authorized administrators for various organizations can access the datastore 118 to add user identifiers and to define the expanded set of parameters 220 on a per organization basis (e.g., the link 210 parameter and/or the data access 212 parameter) and/or on a per user basis (e.g., the type 208 parameter, the link 210 parameter, the data access 212 parameter, the role 216 parameter, the capability 218 parameter, the view 219 parameter). In various examples, owners (e.g., administrators for organizations) of robotic device and/or AI agent resources can define a setting that controls whether parameters (e.g., location 214 parameters, role 216 parameters and/or capability 218 parameters) are discoverable via a query 130.

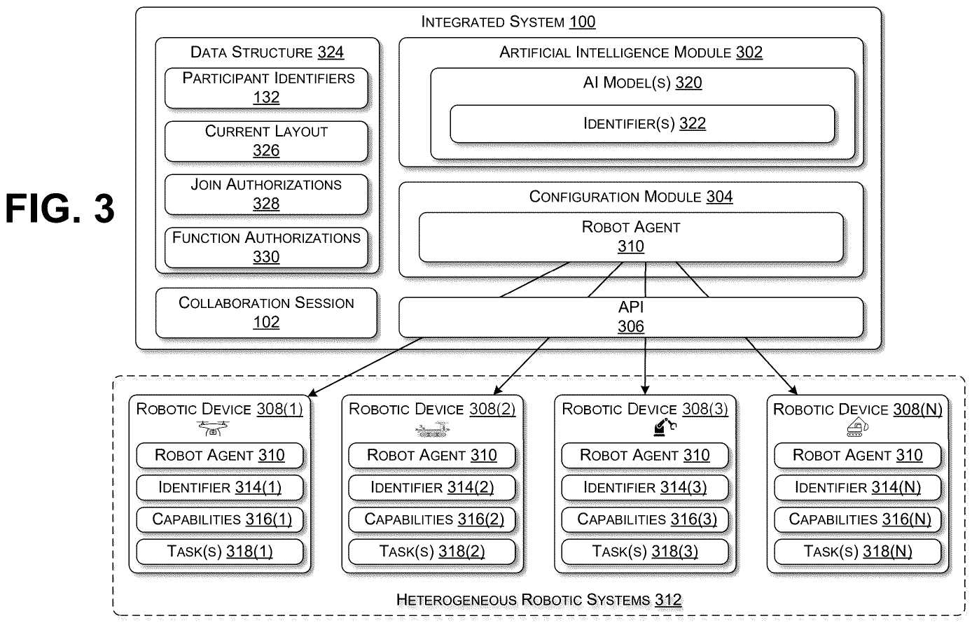

FIG. 3 illustrates further aspects of the integrated system 100 executing the collaboration session 102. The integrated system 100 includes an artificial intelligence (AI) module 302 and a configuration module 304. The functionality described herein in association with the illustrated modules can be performed by a fewer number of modules or a larger number of modules on one device (e.g., server) in the integrated system 100 or spread across multiple devices in the integrated system 100.

The configuration module 304 is configured to expose an application programming interface (API) 306 that allows different types of robotic devices 308(1-N) to access and download a robot agent 310 that enables robotic device participation in the collaboration session 102. The robot agent 310 includes centralized code (e.g., a software development kit, application programming interface(s)) that configures the different types of robotic devices 308(1-N) with communication software that is compatible with the collaboration session 102. That is, after downloading and installing the robot agent 310, a robotic device 308 can join and participate in the collaboration session 102 via the communication (e.g., transmission) of robot data (e.g., sensor data 146 and/or location data 148).

Thus, the robot agent 310 made available by the configuration module 304 via the API 306 configures a bi-directional communication bridge between a robotic device 308 and the collaboration session 102. More specifically, this bi-directional communication bridge connects the robotic device 308 to cloud infrastructure that hosts the collaboration session 102 via different types of networks including private and/or public local area networks (LANs), private and/or public metropolitan area networks (MANs), private and/or public wide area networks (WANs), Wi-Fi networks, public and/or private mobile networks (e.g., 5G networks, LTE networks), satellite networks, radio networks, and so forth.

As illustrated in FIG. 3, the robotic devices 308(1-N) are heterogeneous 312 robotic devices. More specifically, the robotic devices 308(1-N) respectively include identifiers 314(1-N) (e.g., corresponding to identifiers 122) that can either define, or be mapped to, different hardware, firmware, and/or software components. As shown, robotic device 308(1) has an identifier 314(1) associated with a first set of capabilities 316(1) (e.g., as defined via the capability 218 parameter) with respect to hardware, firmware, and/or software components of an unmanned aerial vehicle (UAV) configured to perform particular task(s) 318(1). Robotic device 308(2) has an identifier 314(2) associated with a second set of capabilities 316(2) with respect to hardware, firmware, and/or software components of a track crawler robotic device configured to perform particular task(s) 318(2). Robotic device 308(3) has an identifier 314(3) associated with a third set of capabilities 316(3) with respect to hardware, firmware, and/or software components of an arm-based robotic device configured to perform particular task(s) 318(3) (e.g., pick up and move an object). Robotic device 308(N) has an identifier 314(N) associated with a Nth set of capabilities 316(N) with respect to hardware, firmware, and/or software components of a backhoe robotic device configured to perform particular task(s) 318(N). A version of the robot agent 310 downloaded and installed on the robotic devices 308(1-N) can be a common version. Alternatively, a version of the robot agent 310 downloaded and installed on the robotic devices 308(1-N) can be a customized version (e.g., the centralized code has been tailored based on an identifier 314).

In various examples, the invitation 134 to join the collaboration session 102 is a notification that wakes a robotic device 308 from a sleep state and/or activates the robot agent 310 to enable the bi-directional communication bridge to/from the collaboration session 102. As described above, after a robotic device 308 has joined the collaboration session 102, the robotic device can start participating by communicating (e.g., reporting) sensor data 146 and/or location data 148 to the collaboration session 102.

The AI module 302 provides the collaboration session 102 access to an intelligence backbone in the form of AI models 320 (e.g., multi-modal generative-AI models, large language models (LLMs), small language models (SLMs)) and associated identifiers 322. In various examples, the AI module 302 includes general-purpose type AI models and/or specific-purpose type AI models, as described above. Furthermore, the general-purpose type AI models can serve as a conduit between humans and specific-purpose type AI model(s).

Each type of robotic device 308(1-N) may have a dedicated specific-purpose type AI model to assist with, or support, task(s) 318(1-N). Thus, in various examples, after the robotic devices 308(1-N) join the communication session 102, the corresponding specific-purpose type AI models dedicated to the robotic devices 308(1-N) can be automatically invited to the collaboration session 102. In various examples, AI processing can occur anywhere within a distributed, cloud environment. That is, the AI process can occur at a robotic device 308 (e.g., via a small language model implemented in the robot agent 310), at an edge location, or in the cloud.

In some instances, the AI model(s) 320 comprise large action models (LAMs) and/or small action models (SAMs) that work in combination with other pre-trained or customized models, such as LLMs, SLMs, large multimodal models, and/or small multimodal models. While language models have the main function of generating text, action models can generate and/or perform concrete actions with a given set of instructions or commands from a human participant. Consequently, the AI agent participants 108(1-N) can use action models to act like humans in terms of analyzing data and then acting based on the analysis. For example, while a language model (e.g., LLM, SLM) might be used to understand and respond to a chat message, an action model (e.g., LAM, SAM) could autonomously generate and perform tasks described by the chat message. Consequently, action models are sophisticated components that help an AI agent participant 108 understand and execute complex tasks.

In various examples, components of an action model include a foundational language model, as well as a reinforcement learning from human feedback (RLHF) component or a direct preference optimization (DPO) component to fine tune the foundational language model (e.g., make the foundational language model more accurately understand different areas or topics). The language model is then connected to an external tool (e.g., a robotic device participant) that perform actions on its own, which essentially turns the language model into an action model. Consequently, action models are configured to interact with various systems and/or interfaces to perform tasks that involve actual actions, such as controlling robotic device participants.

Further shown in FIG. 3 is a data structure 324 for the collaboration session 102 and/or interaction environment 138. The data structure 324 includes code reflecting the context of the collaboration session 102 and/or interaction environment 138. To this end, the data structure 324 includes the participant identifiers 132 included in the request 128 and/or retrieved from the datastore 118 based on the query 130 and a current layout 326 of the interaction environment 138. Furthermore, the data structure 324 includes join authorizations 328 indicating, based on the retrieved parameters, whether an individual participant can automatically join the collaboration session 102 or needs to be accepted into the collaboration session 102, as well as function authorizations 330 indicating, based on the retrieved parameters, functions individual participants are allowed to execute in the context of the collaboration session 102.

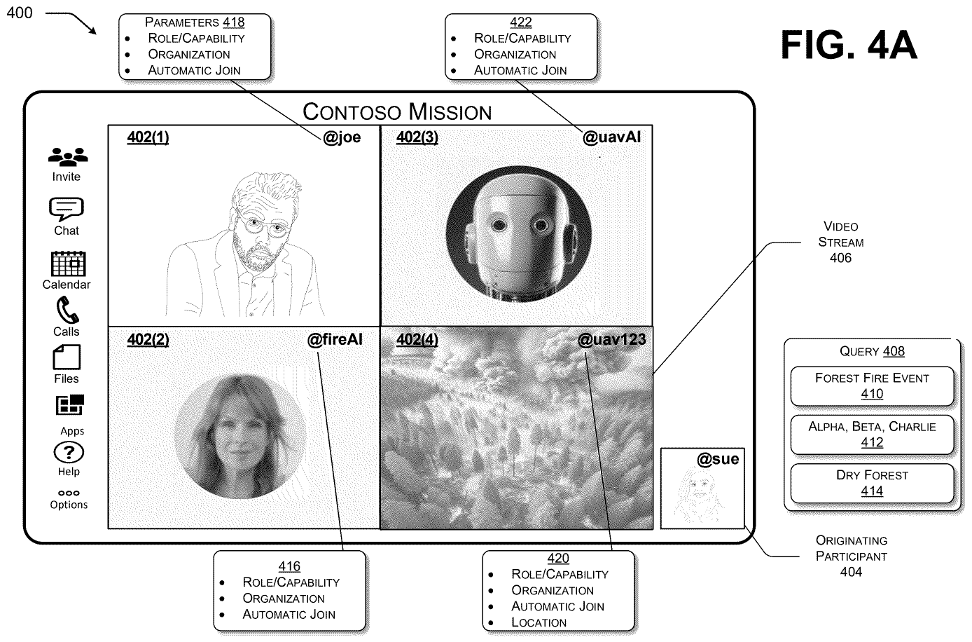

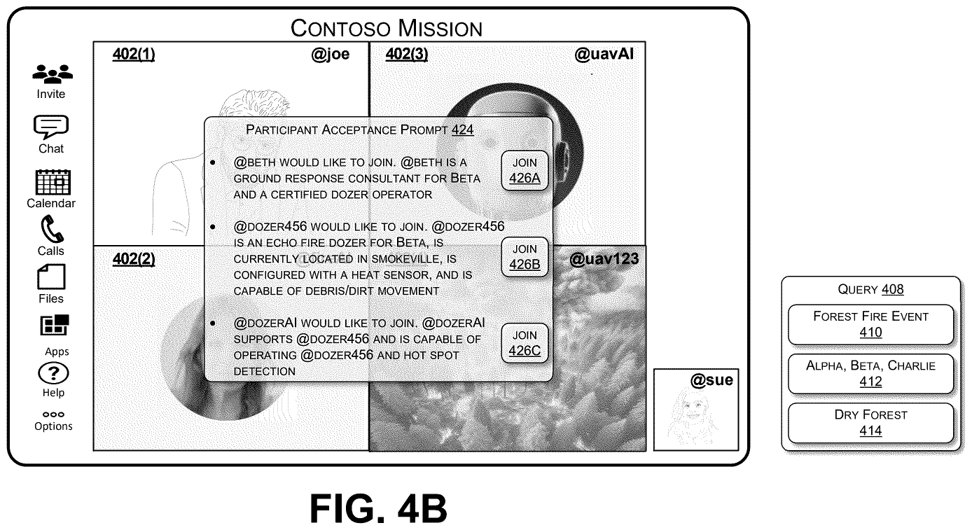

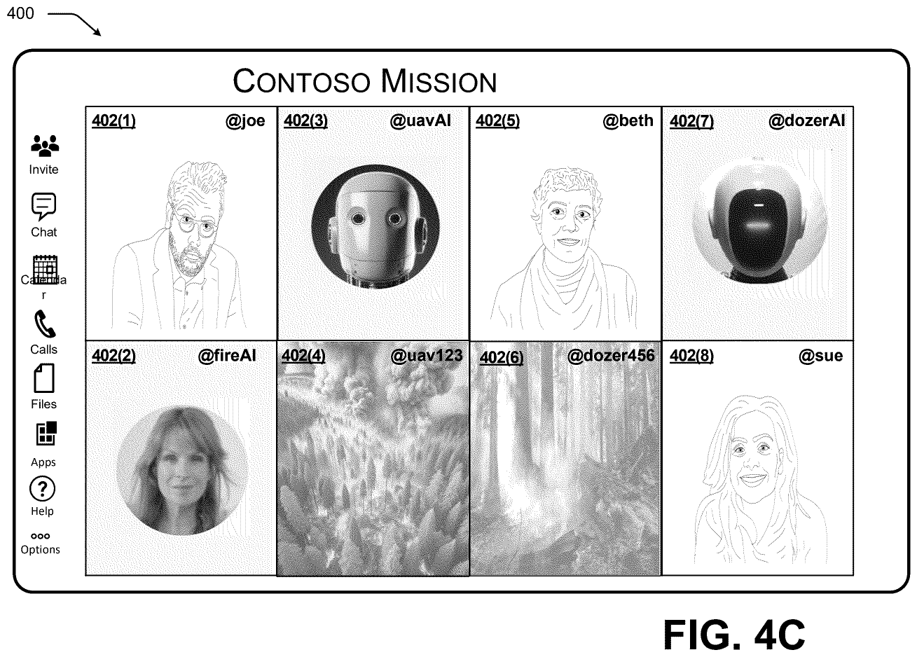

FIG. 4A illustrates an example interaction environment 400 of a communication session 102 where participants are identified based on parameters satisfying a query and joined automatically. The example interaction environment 400 may be displayed via computing device 140A-B. As shown, the mission 110 is entitled the “Contoso Mission”, which is directed to the example event 114 of a forest fire. Accordingly, the interaction environment 400 includes display areas 402(1-4) that display graphical representations 142 for four participants in addition to a display area (e.g., a “Me” display area) for the originating participant 404 “@sue”.

For example, display area 402(1) includes a graphical representation of the human participant 104 identified as “@joe”, in the form of a video stream being captured by a video camera on a computing device. Display area 402(2) includes a graphical representation of an AI agent participant 108 identified as “@fireAI”. Display area 402(3) includes a graphical representation of an AI agent participant 108 identified as “@uavAI”. And display area 402(4) includes a graphical representation of a robotic device participant identified as “@uav123”, e.g., in the form of a video stream 406 being captured by a video capture component embedded in or attached to “@uav123”.

FIG. 4A further illustrates an example query 408 submitted by “@sue”, the originating participant 404, when she decides to create and/or start the collaboration session and provides a corresponding request 128 to do so. As described above, a query includes alphanumeric strings describing a type of event, organization(s) that are likely to be helpful in responding to the type of event, a location in which the type of event is occurring, and/or a description of roles and/or capabilities that are likely to be helpful in responding to the type of event. In FIG. 4A, the query 408 states that the event 114 is a forest fire 410. Additionally or alternatively, the query 408 can identify that organizations Alpha, Beta, and Charlie 412 are organizations that are likely to be helpful in responding to a forest fire event 410. Additionally or alternatively, the query 408 can identify the location of the forest fire as the Dry Forest 414.

The system submits the query 408 to the datastore 118 and, in return, receives identifiers 132 of users associated with parameters that satisfy the query 408, as participants to be invited to the collaboration session for “@sue”. More specifically, the datastore 118 returns the identifier “@fireAI” as this AI agent user is associated with parameters 416 that satisfy the query 408. That is, looking to entry 202(8) in FIG. 2A, “@fireAI” belongs to the Charlie organization, which is specified in the query 408. Moreover, “@fireAI” has a role and/or capabilities that are likely to be helpful in fighting a forest fire. Additionally, because “@fireAI” belongs to the same organization as “@sue” (i.e., the Alpha organization), “@fireAI” can automatically join the collaboration session).

Additionally, the datastore 118 returns the identifier “@joe” as this human user is associated with parameters 418 that satisfy the query 408. That is, looking to entry 202(1) in FIG. 2A, “@joe” belongs to the Alpha organization, which is specified in the query 408. Moreover, “@joe” has a role and/or capabilities that are likely to be helpful in fighting a forest fire. Additionally, based on the link 210 parameter indicating the Charlie organization is linked to the Alpha organization (to which “@sue” belongs), “@joe” can automatically join the collaboration session.

Further, the datastore 118 returns the identifier “@uav123” as this robotic device user is associated with parameters 420 that satisfy the query 408. That is, looking to entry 202(2) in FIG. 2A, “@uav123” belongs to the Alpha organization, which is specified in the query 408. Moreover, “@uav123” has a role and/or capabilities that are likely to be helpful in fighting a forest fire. Further, “@uav123” has a current location—Fire City—that is proximate to the Dry Forest (e.g., within a predefined threshold distance). Additionally, based on the link 210 parameter indicating the Charlie organization is linked to the Alpha organization (to which “@sue” belongs), “@uav123” can automatically join the collaboration session.

Further, the datastore 118 returns the identifier “@uavAI” as this AI agent user is associated with parameters 422 that satisfy the query 408. That is, looking to entry 202(3) in FIG. 2A, “@uavAI” belongs to the Alpha organization, which is specified in the query 408. Moreover, “@uavAI” has a role and/or capabilities that are likely to be helpful in fighting a forest fire. Additionally, based on the link 210 parameter indicating the Charlie organization is linked to the Alpha organization (to which “@sue” belongs), “@uavAI” can automatically join the collaboration session.

Moving on to FIG. 4B, the example interaction environment 400 illustrates a participant acceptance prompt 424. In addition to the datastore 118 returning the identifiers described above with respect to FIG. 4A, the datastore 118 also returns identifiers “@beth”, “@dozer456”, and “@dozerAI” due to their inclusion of parameters that satisfy the query 408. However, because the Beta organization is not linked to the Charlie organization (e.g., the link 210 parameter for entries 202(4-6) in FIG. 2A is null), “@beth”, “@dozer456”, and “@dozerAI” must be accepted into the collaboration session by “@sue” (or another participant with appropriate privileges). Accordingly, the participant acceptance prompt 424 describes the parameters that satisfy the query 408 for each of “@beth”, “@dozer456”, and “@dozerAI”. Moreover, participant acceptance prompt 424 includes respective join user interface elements 426A-C that, when selected, accept each of “@beth”, “@dozer456”, and “@dozerAI” into the collaboration session.

After “@sue” selects the join user interface elements 426A-C in FIG. 4A, FIG. 4C shows how the example interaction environment 400 includes all the participants, e.g., “@joe” in display area 402(1), “@fireAI” in display area 402(2), “@uavAI” in display area 402(3), “@uav 123” in display area 402(4), “@beth” in display area 402(5), “@dozer 456” in display area 402(6), “@dozerAI” in display area 402(7), and “@sue” in display area 402(8) (e.g., the “Me” display area).

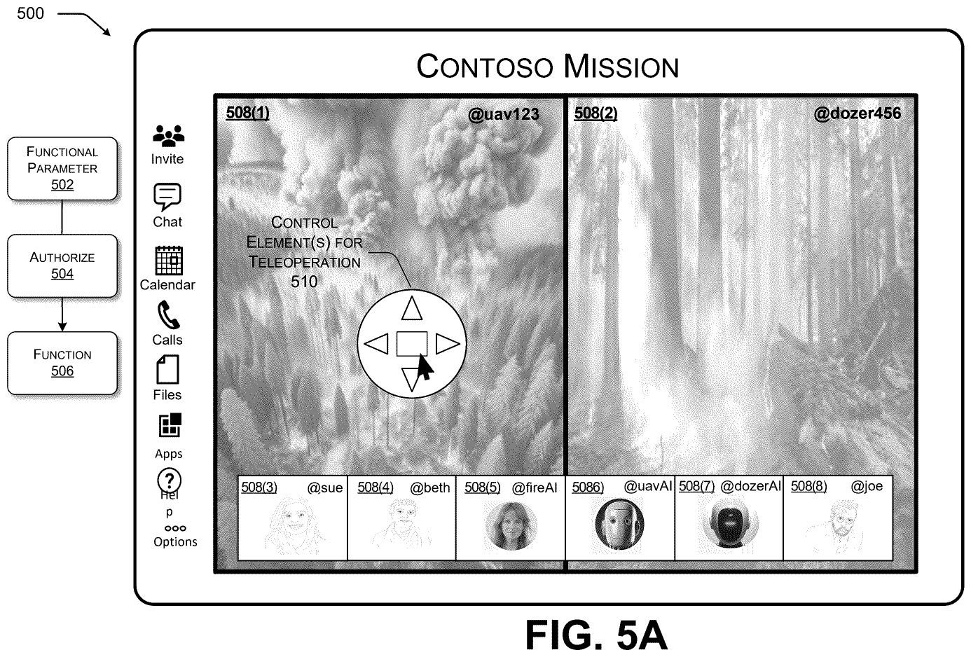

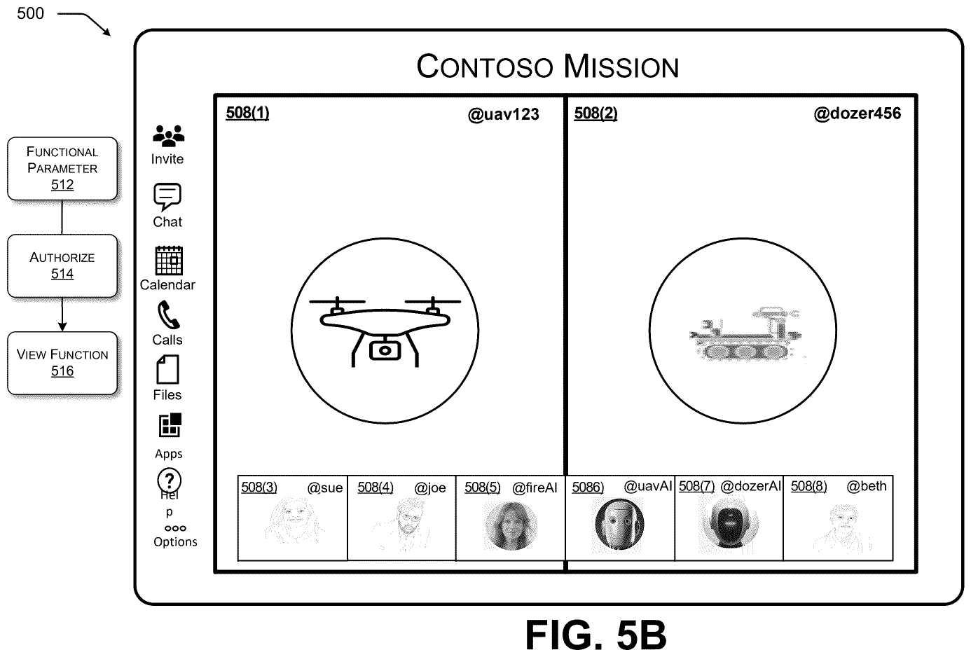

FIG. 5A illustrates an example interaction environment 500 in which a functional parameter 502 (e.g., the role parameter and/or the capability parameter) is used to authorize 504 a participant to implement a function 506 within the context of the collaboration session. In this example, the function 506 is teleoperation of a robotic device participant. The example environment 500 reflects a different layout compared to the layout illustrated in FIGS. 4A-4C. In the layout of FIG. 5A, the video streams from the robotic device participants are displayed more prominently in display areas 508(1-2), while the other human and/or AI agent participants are displayed less prominently in display areas 508(3-8). The interaction environment 500 is displayed on Joe's computing device. In entry 202(1) of FIG. 2A, the role 216 parameter indicates that “@joe” is an aerial response consultant and the capability 218 parameter indicates that “@joe” is a certified UAV operator. Consequently, one or both of these parameters provide a basis for authorizing “@joe” to teleoperate “@uav123” in the context of the collaboration session, e.g., via the control element(s) 510 for teleoperation. In contrast, in entry 202(4) of FIG. 2A, the role 216 parameter indicates that “@beth” is a ground response consultant and the capability 218 parameter indicates that “@beth” is a certified dozer operator. Consequently, “@beth” is not authorized to teleoperate “@uav123” in the context of the collaboration session. However, “@beth” is authorized to teleoperate “@dozer456” in the context of the collaboration session, while “@joe” is not.

FIG. 5B illustrates the example interaction environment 500 of FIG. 5B. However, the interaction environment is being viewed from a device that belongs to Beth (e.g., thus “@joe” is switched to display area 508(4) and “@beth” is switched to display area 508(8)). In this example, a functional parameter 512 is the view parameter, which authorizes 514 a human participant to implement a view function 516 within the context of the collaboration session. Referring back to FIG. 2A, “@joe” has viewing privileges, and thus, the graphical representations for “@uav123” and “@dozer456” in display areas 508(1) and 508(2) include video streams from the robotic device participants, as shown in FIG. 5A. However, “@beth” does not have viewing privileges, and thus, the graphical representations for “@uav123” and “@dozer456” in display areas 508(1) and 508(2) of FIG. 5B do not include the video streams, but rather, static images representing the robotic device participants.

FIGS. 4A-C and 5A-5B include a smaller number of graphical representations for a smaller number of respective participants in a collaboration session 102. However, it is understood in the context of this disclosure that a collaboration session 102 can have a larger number of participants (e.g., twenty participants, thirty participants, fifty participants) depending on the size and/or scope of the mission 110. Consequently, via the interaction environment 138 provided by a collaboration session 102, human participants 104(1-N) are provided with a centralized space that allows the human participants 104(1-N) to not only view helpful resources (e.g., robotic device participants 106(1-N), AI agent participants 108(1-N)) that are available and/or deployed to assist in completion of the mission 110, but also interact with the helpful resources in a way that provides effective and efficient coordination.

Additionally, while FIGS. 4A-C and 5A-5B, as well as FIGS. 2A-2B, are directed to a fire event in a forest geographical environment, it is noted that the event can be any type of event in any type of geographical environment. For example, a warehouse or manufacturing line can include a large number of robotic devices, some of which are capable of implementing different functions. As multiple different tasks with different priorities are often being implemented in the warehouse or manufacturing line, the techniques described herein can be used to identify robotic devices that can be reallocated from implementing a first function on a lower priority task to implementing a second function on a higher priority task in warehouse or manufacturing line (e.g., in a response to an event that raises a priority for the task).

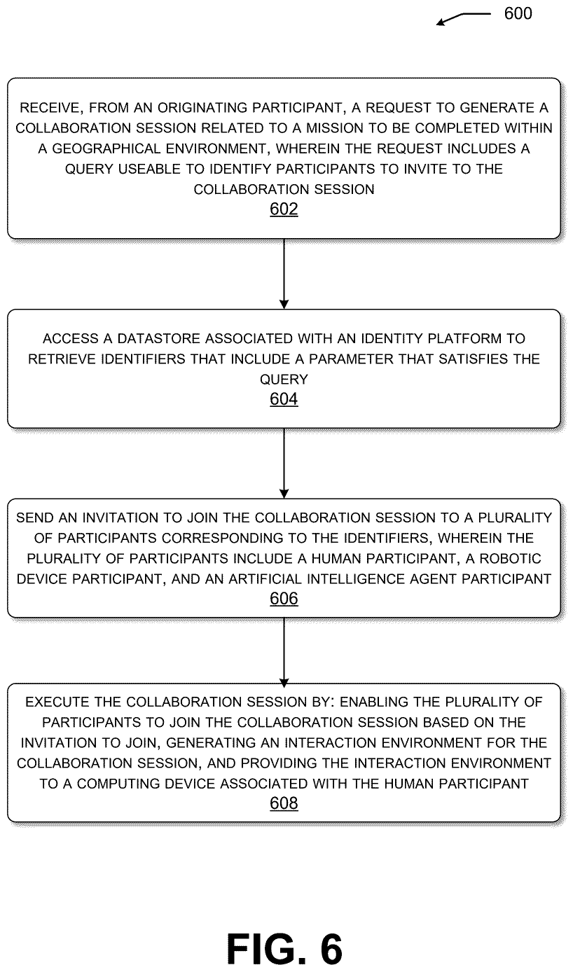

FIG. 6 illustrates a process 600 for accesses a datastore to retrieve security and/or functional parameters useable to authorize human participants, robotic device participants, and/or artificial intelligence agent participants to join a collaboration session and/or to implement functions within the context of the collaboration session. The process 600 begins at operation 602 where a system receives, from an originating participant, a request to generate a collaboration session related to a mission to be completed within a geographical environment, wherein the request includes a query useable to identify participants to invite to the collaboration session.

At operation 604, the system accesses a datastore associated with an identity platform to retrieve identifiers that include a parameter that satisfies the query.

At operation 606, the system sends an invitation to join the collaboration session to a plurality of participants corresponding to the identifiers, wherein the plurality of participants include a human participant, a robotic device participant, and an artificial intelligence agent participant.

At operation 608, the system executes the collaboration session by: enabling the plurality of participants to join the collaboration session based on the invitation to join, generating an interaction environment for the collaboration session, and providing the interaction environment to a computing device associated with the human participant.

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the processes or an alternate processes. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated processes can end at any time and need not be performed in their entirety. Some or all operations of the processes, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the processes can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

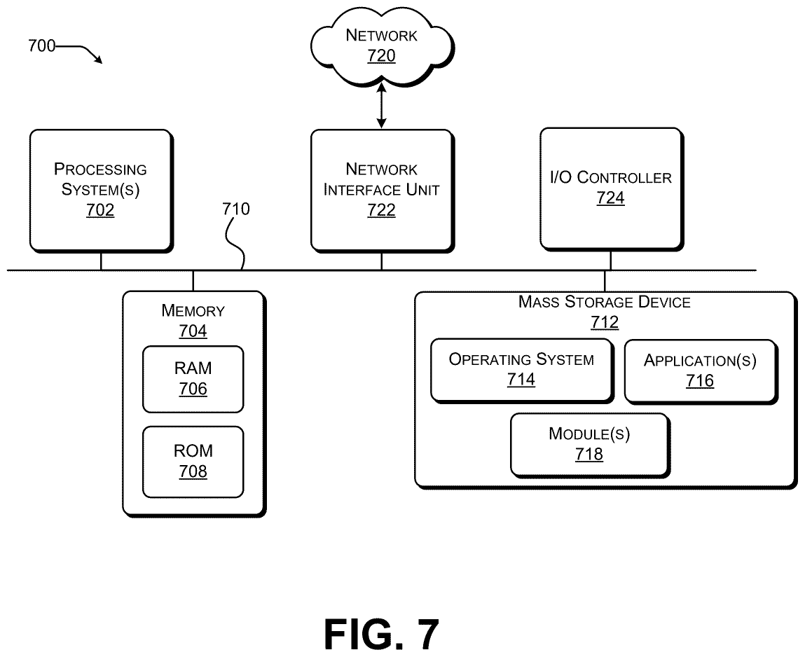

FIG. 7 shows additional details of an example computer architecture 700 for a device, such as a computer (e.g., computing device 140A-B) or a server configured as part of the integrated system 100, capable of executing computer instructions (e.g., a module or a program component described herein). The computer architecture 700 illustrated in FIG. 7 includes processing unit(s) 702, a system memory 704, including a random-access memory 706 (“RAM”) and a read-only memory (“ROM”) 708, and a system bus 710 that couples the memory 704 to the processing unit(s) 702.

Processing unit(s), such as processing unit(s) 702, can represent, for example, a CPU-type processing unit, a GPU-type processing unit, a field-programmable gate array (FPGA), another class of digital signal processor (DSP), or other hardware logic components that may, in some instances, be driven by a CPU. For example, and without limitation, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), etc.

A basic input/output system containing the basic routines that help to transfer information between elements within the computer architecture 700, such as during startup, is stored in the ROM 708. The computer architecture 700 further includes a mass storage device 712 for storing an operating system 714, application(s) 716, modules 718, and other data described herein.

The mass storage device 712 is connected to processing unit(s) 702 through a mass storage controller connected to the bus 710. The mass storage device 712 and its associated computer-readable media provide non-volatile storage for the computer architecture 700. Although the description of computer-readable media contained herein refers to a mass storage device, it should be appreciated by those skilled in the art that computer-readable media can be any available computer-readable storage media or communication media that can be accessed by the computer architecture 700.

Computer-readable media can include computer-readable storage media and/or communication media. Computer-readable storage media can include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (RAM), static random-access memory (SRAM), dynamic random-access memory (DRAM), phase change memory (PCM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 700 may operate in a networked environment using logical connections to remote computers through the network 720. The computer architecture 700 may connect to the network 720 through a network interface unit 722 connected to the bus 710. The computer architecture 700 also may include an input/output controller 724 for receiving and processing input from a number of other devices, including a keyboard, mouse, touch, or electronic stylus or pen. Similarly, the input/output controller 724 may provide output to a display screen, a printer, or other type of output device.

It should be appreciated that the software components described herein may, when loaded into the processing unit(s) 702 and executed, transform the processing unit(s) 702 and the overall computer architecture 700 from a general-purpose computing system into a special-purpose computing system customized to facilitate the functionality presented herein. The processing unit(s) 702 may be constructed from any number of transistors or other discrete circuit elements, which may individually or collectively assume any number of states. More specifically, the processing unit(s) 702 may operate as a finite-state machine, in response to executable instructions contained within the software modules disclosed herein. These computer-executable instructions may transform the processing unit(s) 702 by specifying how the processing unit(s) 702 transition between states, thereby transforming the transistors or other discrete hardware elements constituting the processing unit(s) 702.

The disclosure presented herein also encompasses the subject matter set forth in the following clauses.
Example Clause A, a method comprising: receiving, from an originating participant, a request to generate a collaboration session related to a mission to be completed within a geographical environment, wherein the request includes a query useable to identify participants to invite to the collaboration session; accessing a datastore associated with an identity platform to retrieve identifiers that include a parameter that satisfies the query; sending an invitation to join the collaboration session to a plurality of participants corresponding to the identifiers, wherein the plurality of participants include a human participant, a robotic device participant, and an artificial intelligence agent participant; executing the collaboration session by: enabling the plurality of participants to join the collaboration session based on the invitation to join; generating an interaction environment for the collaboration session; and providing the interaction environment to a computing device associated with the human participant.
Example Clause B, the method of Example Clause A, wherein the query specifies a type of event and the parameter that satisfies the query indicates a role related to the type of event.
Example Clause C, the method of Example Clause A or Example Clause B, wherein the query specifies a type of event and the parameter that satisfies the query indicates a capability related to the type of event.
Example Clause D, the method of any one of Example Clauses A through C, wherein: the query specifies a geographical area associated with the geographical environment; and the parameter that satisfies the query indicates that a current location of a robotic device participant is within the geographical area.
Example Clause E, the method of any one of Example Clauses A through D, wherein the datastore comprises: a plurality of first entries that include human identifiers; a plurality of second entries that include robotic device identifiers; and a plurality of third entries that include artificial intelligence agent identifiers.
Example Clause F, the method of any one of Example Clauses A through E, further comprising enabling one or more first participants of the plurality of participants to automatically join the collaboration session based on one or more corresponding first link parameters, in the datastore, indicating that the one or more first participants are authorized to automatically join the collaboration session, wherein the one or more first participants belong to a first organization that is different than a second organization to which the originating participant belongs.
Example Clause G, the method of Example Clause F, further comprising requiring one or more second participants of the plurality of participants to be accepted into the collaboration session by the originating participant based on one or more second link parameters, in the datastore, indicating that the one or more second participants are not authorized to automatically join the collaboration session, wherein the one or more second participants belong to a third organization that is different than the second organization to which the originating participant belongs.
Example Clause H, the method of any one of Example Clauses A through G, wherein the parameter authorizes a participant to implement a function in a context of the collaboration session.
Example Clause I, the method of Example Clause H, wherein the function comprises teleoperation of the robotic device participant.
Example Clause J, the method of any one of Example Clauses A through G, wherein an additional parameter retrieved from the datastore authorizes the human participant to view a video stream from the robotic device participant in a context of the collaboration session.
Example Clause K, a system comprising: a processing system; and a computer readable storage medium storing instructions that, when executed by the processing system, cause the system to perform operations comprising: receiving, from an originating participant, a request to generate a collaboration session related to a mission to be completed within a geographical environment, wherein the request includes a query useable to identify participants to invite to the collaboration session; accessing a datastore associated with an identity platform to retrieve identifiers that include a parameter that satisfies the query; sending an invitation to join the collaboration session to a plurality of participants corresponding to the identifiers, wherein the plurality of participants include a human participant, a robotic device participant, and an artificial intelligence agent participant; executing the collaboration session by: enabling the plurality of participants to join the collaboration session based on the invitation to join; generating an interaction environment for the collaboration session; and providing the interaction environment to a computing device associated with the human participant.
Example Clause L, the system of Example Clause K, wherein the query specifies a type of event and the parameter that satisfies the query indicates a role related to the type of event.
Example Clause M, the system of Example Clause K or Example Clause L, wherein the query specifies a type of event and the parameter that satisfies the query indicates a capability related to the type of event.
Example Clause N, the system of any one of Example Clauses K through M, wherein: the query specifies a geographical area associated with the geographical environment; and the parameter that satisfies the query indicates that a current location of a robotic device participant is within the geographical area.
Example Clause O, the system of any one of Example Clauses K through N, wherein the datastore comprises: a plurality of first entries that include human identifiers; a plurality of second entries that include robotic device identifiers; and a plurality of third entries that include artificial intelligence agent identifiers.
Example Clause P, the system of any one of Example Clauses K through O, wherein the operations further comprise enabling one or more first participants of the plurality of participants to automatically join the collaboration session based on one or more corresponding first link parameters, in the datastore, indicating that the one or more first participants are authorized to automatically join the collaboration session, wherein the one or more first participants belong to a first organization that is different than a second organization to which the originating participant belongs.
Example Clause Q, the system of Example Clause P, wherein the operations further comprise requiring one or more second participants of the plurality of participants to be accepted into the collaboration session by the originating participant based on one or more second link parameters, in the datastore, indicating that the one or more second participants are not authorized to automatically join the collaboration session, wherein the one or more second participants belong to a third organization that is different than the second organization to which the originating participant belongs.
Example Clause R, the system of any one of Example Clauses K through Q, wherein the parameter authorizes a participant to implement a function in a context of the collaboration session.
Example Clause S, the system of any one of Example Clauses K through Q, wherein an additional parameter retrieved from the datastore authorizes the human participant to view a video stream from the robotic device participant in a context of the collaboration session.
Example Clause T, a computer readable storage medium storing instructions that, when executed by a processing system, cause a system to perform operations comprising: receiving, from an originating participant, a request to generate a collaboration session related to a mission to be completed within a geographical environment, wherein the request includes a query useable to identify participants to invite to the collaboration session; accessing a datastore associated with an identity platform to retrieve identifiers that include a parameter that satisfies the query; sending an invitation to join the collaboration session to a plurality of participants corresponding to the identifiers, wherein the plurality of participants include a human participant, a robotic device participant, and an artificial intelligence agent participant; executing the collaboration session by: enabling the plurality of participants to join the collaboration session based on the invitation to join; generating an interaction environment for the collaboration session; and providing the interaction environment to a computing device associated with the human participant.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the scope of the inventions disclosed herein. The accompanying claims and their equivalents are intended to cover such forms or modifications as would fall within the scope of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method comprising:
receiving, from an originating participant, a request to generate a collaboration session related to a mission to be completed within a geographical environment, wherein the request includes a query useable to identify participants to invite to the collaboration session;
accessing a datastore associated with an identity platform to retrieve identifiers that include a parameter that satisfies the query;
sending an invitation to join the collaboration session to a plurality of participants corresponding to the identifiers, wherein the plurality of participants include a human participant, a robotic device participant, and an artificial intelligence agent participant;
executing the collaboration session by:
enabling the plurality of participants to join the collaboration session based on the invitation to join;
generating an interaction environment for the collaboration session; and
providing the interaction environment to a computing device associated with the human participant.

2. The method of claim 1, wherein the query specifies a type of event and the parameter that satisfies the query indicates a role related to the type of event.

3. The method of claim 1, wherein the query specifies a type of event and the parameter that satisfies the query indicates a capability related to the type of event.

4. The method of claim 1, wherein:
the query specifies a geographical area associated with the geographical environment; and
the parameter that satisfies the query indicates that a current location of a robotic device participant is within the geographical area.

5. The method of claim 1, wherein the datastore comprises:
a plurality of first entries that include human identifiers;
a plurality of second entries that include robotic device identifiers; and
a plurality of third entries that include artificial intelligence agent identifiers.

6. The method of claim 1, further comprising enabling one or more first participants of the plurality of participants to automatically join the collaboration session based on one or more corresponding first link parameters, in the datastore, indicating that the one or more first participants are authorized to automatically join the collaboration session, wherein the one or more first participants belong to a first organization that is different than a second organization to which the originating participant belongs.

7. The method of claim 6, further comprising requiring one or more second participants of the plurality of participants to be accepted into the collaboration session by the originating participant based on one or more second link parameters, in the datastore, indicating that the one or more second participants are not authorized to automatically join the collaboration session, wherein the one or more second participants belong to a third organization that is different than the second organization to which the originating participant belongs.

8. The method of claim 1, wherein the parameter authorizes a participant to implement a function in a context of the collaboration session.

9. The method of claim 8, wherein the function comprises teleoperation of the robotic device participant.

10. The method of claim 1, wherein an additional parameter retrieved from the datastore authorizes the human participant to view a video stream from the robotic device participant in a context of the collaboration session.

11. A system comprising:
a processing system; and
a computer readable storage medium storing instructions that, when executed by the processing system, cause the system to perform operations comprising:
receiving, from an originating participant, a request to generate a collaboration session related to a mission to be completed within a geographical environment, wherein the request includes a query useable to identify participants to invite to the collaboration session;
accessing a datastore associated with an identity platform to retrieve identifiers that include a parameter that satisfies the query;
sending an invitation to join the collaboration session to a plurality of participants corresponding to the identifiers, wherein the plurality of participants include a human participant, a robotic device participant, and an artificial intelligence agent participant;
executing the collaboration session by:
enabling the plurality of participants to join the collaboration session based on the invitation to join;
generating an interaction environment for the collaboration session; and
providing the interaction environment to a computing device associated with the human participant.

12. The system of claim 11, wherein the query specifies a type of event and the parameter that satisfies the query indicates a role related to the type of event.

13. The system of claim 11, wherein the query specifies a type of event and the parameter that satisfies the query indicates a capability related to the type of event.

14. The system of claim 11, wherein:
the query specifies a geographical area associated with the geographical environment; and
the parameter that satisfies the query indicates that a current location of a robotic device participant is within the geographical area.

15. The system of claim 11, wherein the datastore comprises:
a plurality of first entries that include human identifiers;
a plurality of second entries that include robotic device identifiers; and
a plurality of third entries that include artificial intelligence agent identifiers.

16. The system of claim 11, wherein the operations further comprise enabling one or more first participants of the plurality of participants to automatically join the collaboration session based on one or more corresponding first link parameters, in the datastore, indicating that the one or more first participants are authorized to automatically join the collaboration session, wherein the one or more first participants belong to a first organization that is different than a second organization to which the originating participant belongs.

17. The system of claim 16, wherein the operations further comprise requiring one or more second participants of the plurality of participants to be accepted into the collaboration session by the originating participant based on one or more second link parameters, in the datastore, indicating that the one or more second participants are not authorized to automatically join the collaboration session, wherein the one or more second participants belong to a third organization that is different than the second organization to which the originating participant belongs.

18. The system of claim 11, wherein the parameter authorizes a participant to implement a function in a context of the collaboration session.

19. The system of claim 11, wherein an additional parameter retrieved from the datastore authorizes the human participant to view a video stream from the robotic device participant in a context of the collaboration session.

20. A computer readable storage medium storing instructions that, when executed by a processing system, cause a system to perform operations comprising:
receiving, from an originating participant, a request to generate a collaboration session related to a mission to be completed within a geographical environment, wherein the request includes a query useable to identify participants to invite to the collaboration session;
accessing a datastore associated with an identity platform to retrieve identifiers that include a parameter that satisfies the query;
sending an invitation to join the collaboration session to a plurality of participants corresponding to the identifiers, wherein the plurality of participants include a human participant, a robotic device participant, and an artificial intelligence agent participant;
executing the collaboration session by:
enabling the plurality of participants to join the collaboration session based on the invitation to join;
generating an interaction environment for the collaboration session; and
providing the interaction environment to a computing device associated with the human participant.
